(19) United States
(12) Patent Application Publication
(10) Pub. No.: US 2008/0202698 A1
(43) Pub. Date: Aug. 28, 2008

(54) DUAL OVERHEAD DOOR SYSTEM, KIT AND METHOD

(76) Inventors: Eric L. Dalton, Naples, FL (US); William F. Polley, Marco Island, FL (US)

Correspondence Address: EDWARD M. LIVINGSTON, PA, 963 TRAIL TERRACE DRIVE, NAPLES, FL, 34103, US

(21) Appl. No.: 11/678,991

(22) Filed: Feb. 26, 2007

(51) Int. Cl. E06B 3/32

(52) U.S. Cl. 160/89

(57) ABSTRACT

A dual overhead door system having a pair of vertical tracks (5) mounted on either side of a door opening which is connected to a pair of dual spaced apart horizontal tracks (3, 4). The horizontal tracks (3, 4) have a curved segment (6) wherein horizontal tracks meet at a junction to form a single track connected to a top of the vertical track (5). The curved segment in the horizontally tracks contain a special swivel gate (7) which blocks either of the horizontal tracks to keep one door from moving into the vertical section when the other door is already in place and to provide minimum distance between the horizontal tracks for installation in low ceiling applications. A kit and method for converting a single overhead door system into a dual overhead door system is also provided.

### BACKGROUND OF THE INVENTION

This invention relates to overhead door enclosures and, more particularly, a dual overhead door system that has dual horizontal tracks and a single vertical track, employing a swivel gate that allows two doors, such as a conventional garage door and a screen door, to be utilized.

Many people find it desirable to open garage doors and work in a garage for cooling purposes and to increase ambient light. Unfortunately, when a garage door is raised the persons inside are exposed to insects, leaves and other ambient conditions. As a result, various garage screen door systems have been created.

Some systems have a horizontal tube attached on top of the door opening from which a screen can be lowered when desired. However, one drawback of such a horizontal tube system is that it decreases the overall height of the garage door opening, thereby making it difficult or impossible to drive larger vehicles, such as sport utility vehicles, into the garage. A second drawback is that such systems cannot be used with an arched door, as such requires a horizontal top. Furthermore, such systems are obtrusively visible from the outside of a home.

Other screen door systems install screens vertically on the sides of the opening of the garage door from which the screen door must be pulled across sideways. However, such systems also reduce the width of the garage door opening.

As a result, still others have invented dual overhead track systems for doors which hold one solid door and one screen door that can be brought down into one pair of vertical tracks as desired. Unfortunately, such dual track systems require a large overhead space between the ceiling and garage door opening due to employing cumbersome mechanisms necessary to block one door from coming down when another door is in place. Accordingly, such systems require a large space between the top of the garage door opening and the garage ceiling for installation and can only fit a minority of garages in the United States.

Thus, a need exists for a dual overhead garage door system that can fit any garage door opening

The relevant prior art of which the inventors are aware includes the following patents:

| Patent No. | | |
|---|---|---|
| (U.S. unless | | |
| stated otherwise) | Inventor | Issue/Publication Date |
| 2006/0037715 | McClure | Feb. 23, 2006 |
| 6,289,963 | Vaske | Sep. 18, 2001 |
| 2,072,092 | Blodgett | Mar. 2, 1937 |
| 5,408,789 | Plfeger | Apr. 25, 1995 |
| 5,050,660 | Bleichwehl et al. | Sep. 24, 1991 |
| 5,848,630 | Manzo | Dec. 15, 1998 |
| 3,021,896 | Buono, et al. | Feb. 20, 1962 |
| 3,103,967 | Gaschen | Sep. 17, 1963 |

### SUMMARY OF THE INVENTION

The primary object of the present invention is to provide an overhead door system that provides for the use of a screen panel door in addition to the conventional solid door.

Another object of the present is to provide such a system that can fit most all garage door openings regardless of the ceiling height or shape of the door opening.

A further object of the present invention is to provide such a system with a locking gate to prevent a second door from entering the vertical track when it is already occupied by another door.

An additional object of the present invention is to provide an overhead door system kit that can be retro-fitted into existing conventional systems.

An even further object of the present invention is to provide such an overhead door system that can provide for selective motorization between the two doors.

The present invention fulfills the above and other objects by providing a dual overhead door system employing a horizontal track section having a pair of dual spaced-apart parallel tracks suspended from a ceiling of a structure with a curved segment proximate the door opening connected together at a juncture to form a single vertical track section at a lower end extending to the floor on both sides of the door opening. Each door has sets of rollers on each side for movably returning the door within the horizontal tracks.

A gate mounted in the curved segment of the horizontal track section swivels from an upper end into the curved segment of the other track when one of said doors is moved into the vertical track section.

Either one or both of the doors may be operated manually, independently motorized, or operated by one motor and be selectively moved into position as desired. The gate is made of two curvilinear pieces connected together and can be used on either pair of horizontal tracks.

A kit for the system may be provided to convert conventional single overhead door systems to a dual overhead door system. The kit would contain the dual horizontal track section, the gate and at least one foldable door, most likely a screen door for use in conjunction with a conventional solid garage door already in use.

A method of converting a single overhead door system using the dual track kit would be to cut the vertical track section of a top, by removing the pair of single horizontal tracks in a conventional system and then attach dual horizontal track section to the top of the vertical section at the curved end. Then, the first and second doors can be installed in each of the two horizontal tracks.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective plan view of the dual overhead garage system of the present invention showing a conventional garage door in a horizontal position with screen panel door in the vertical position;

FIG. 2 is a side view of one side of the garage door system of the present invention;

FIG. 3 is a partial view, an enlarged scale, of one of the tracks showing insertable blocking gate in the curved segment of the dual horizontal track; and

FIG. 4 is a side plan view on a large scale of the gate of the present invention.

### DESCRIPTION OF THE PREFERRED EMBODIMENTS

For purposes of describing the preferred embodiment, the terminology used in reference to the numbered components in the drawings is as follows:

1. screened garage door

2. conventional door

3. lower horizontal track

4. upper horizontal track

5. vertical track section

6. horizontal track curved segment

7. door blocking gate

8. track ceiling strut

9. track connector plate

10. gate pivot

11. rollers

12. lower door motor

13. conventional door motor

14. outer gate piece

15. inner gate piece

16. gate piece rivets

17. ceiling

18. floor

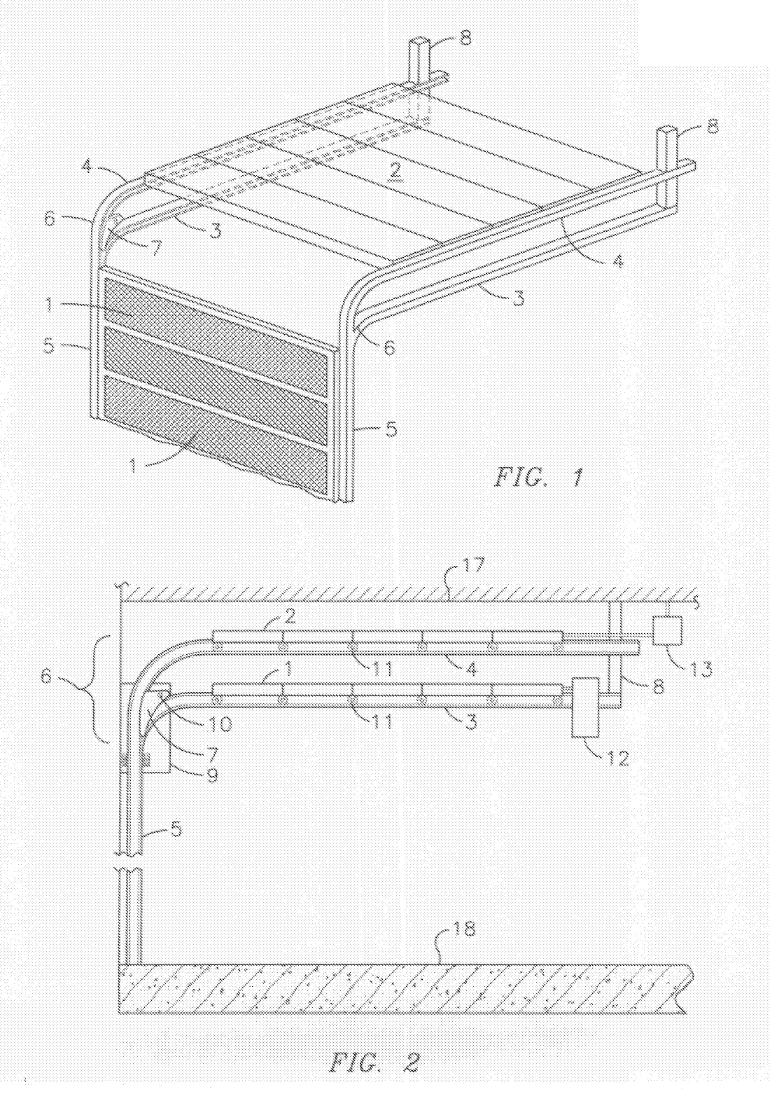

Referring to the drawings, FIG. 1 shows a screen panel door 1, in a “down” position on a pair of vertical tracks section 5 and a conventional door 2 in an “up” position upon the horizontal tracks 4. A second lower pair of horizontal tracks 3 is provided for holding the screen door 1 when it is also in a “up” position. The upper and lower horizontal tracks 4 and 3, respectively, have forward curved segment 6 which curves downward to attach to the top of the vertical track 5. A gate 7 in the curved segment 6 is provided to block one of the doors when an opposite door is in the “down” position. The gate 7 is also used for door placement to guide the proper door on the proper track.

In FIG. 2, a side plan view of one side of the dual overhead door system shows both doors 1 and 2 on the horizontal tracks, 3 and 4, both doors being in the “up” position. Each door is attached to rollers 11 which are mounted in the tracks so that the doors are moveably mounted within the tracks. Generally, the rear end of the tracks are mounted to the ceiling 17 by strut 8. Each of the doors may be separately motorized as shown by attachment to motor 12 and 13 or powered by a single motor which can be selectively activated to move either door one at a time within the tracks. A connector plate 9 may be used to connect the horizontal and vertical tracks to which is mounted a gate 7 that is attached and pivots on a pivot pin 10 to block an opposite track when one door is in the “down” vertical position on the vertical tracks 5 so the door does not come down. The vertical tracks 5 are secured on both sides of the door opening.

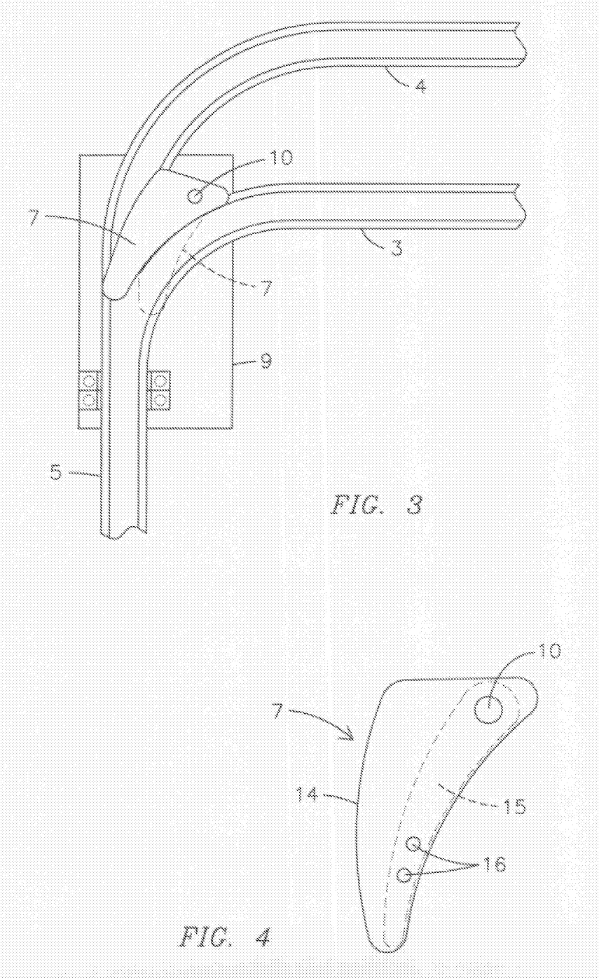

FIG. 3 shows the details of the swivel blocking gate 7. In the solid line form, the blocking gate 7 is shown when it is blocking the upper horizontal track 4, which would be the case when a door on the lower track 3 is in the “down” position in the vertical track 5. In the dotted line form, the gate 7 is shown when it is blocking the lower track 3 which would be the case when the door of the upper track 4 is in the vertical track 5. In this manner damage would be prevented when one of the doors is in the vertical position.

The special design of the swivel gate 7 is shown in more detail in FIG. 4. Although the gate 7 could be made of one piece, which wold require different shapes for each side of the horizontal track, the gate would preferably be made of two pieces, an outer piece 14 and inner gate piece 15, secured together by rivets 16 to either side of the horizontal tracks. The gate will be swivel mounted to a pivot pin 10 so that it could swivel easily to block either door. The special banana-like shape of the gate 7 enables the dual track system of the present invention to be installed in any standard garage regardless of the height of the ceiling 17, as horizontal tracks 3 and 4 require minimal distance between them.

Thus, the dual overhead door system of the present invention will allow the homeowner to install the system originally in their home, in the garage or as a kit to retro-fit current single overhead door system. Such a kit would contain the horizontal track section 3 and 4 and a second door, preferably a screen door 1 with the already-existing conventional door.

Using the kit, an installer would merely cut the vertical rail 5 at a top section and insert the horizontal track section 3 and 4 in its place. Then the screen door 1 could be installed in the vertical horizontal track section 3 where the conventional door 2 is in the upper track 4. Although only a few embodiments of the present invention have been described in detail hereinabove, all improvements and modifications to this invention within the scope or equivalents of the claims are included as part of the invention.

1. A dual overhead door system for use in a structure having a door opening, a vertical wall, a floor and a ceiling, said system comprising:
a horizontal track section having a pair of dual spaced-apart parallel tracks suspended from the ceiling, said tracks each having a curved segment at a forward end to form a single vertical track at a lower end of the curved segment;
a vertical track section having a pair of single vertical tracks connected to the curved segment of the horizontal track section, said vertical track section extending to the floor on each side of the door opening;
first and second foldable doors having sets of rollers on each side of each door, said rollers being movably mounted within the horizontal tracks; and
a curvilinear gate mounted in the curved segment of the horizontal track section which swivels at an upper end to block one of the horizontal tracks when one of the doors is already in a “down” position within the vertical track.

2. The dual overhead door system of claim 1 wherein at least one of the doors is moveable by motorized means.

3. The dual overhead door system of claim 2 wherein the motorized means can be activated selectively as between which of the doors to be moved.

4. The dual overhead system of claim 1 wherein the curvilinear gate is comprised of two curvilinear pieces attached to each other wherein the two pieces in combination can be used on either pair of the horizontal track sections.

5. The dual overhead system of claim 1 wherein one of said doors is a screen panel door.

6. A kit for converting a conventional single overhead door system in a structure having a door opening, a vertical wall, a floor and a ceiling to a dual overhead door system, said kit comprising:
a horizontal track section having a pair of dual spaced-apart parallel tracks to be suspended from the ceiling, said tracks having a curved segment at a forward end to form a single vertical track at a lower end of the curved segment;
an additional foldable door having rollers on each end for mounting in each of the horizontal tracks; and
a curvilinear gate mounted in the curved segment of the horizontal track section which swivels at an upper end to block one of the horizontal tracks when one of the doors is already in a “down” position within the vertical track.

7. The kit of claim 6 wherein the additional foldable door is comprised of screen panels.

8. A method for converting a single overhead door system in a structure having a door opening, a vertical wall, a floor and a ceiling to a dual overhead door system using a kit comprising:
a horizontal track section having a pair of dual spaced-apart parallel tracks to be suspended from the ceiling, said tracks having a curved segment at a forward end to form a single vertical track at a lower end of the curved segment;
an additional foldable door having rollers on each end for mounting in each of the horizontal tracks; and
a curvilinear gate mounted in the curved segment of the horizontal track section which swivels at an upper end to block one of the horizontal tracks when one of the doors is already in a “down” position within the vertical track, said method comprising the steps of:
A. removing the single horizontal track section;
B. attaching the dual horizontal track section to a top of the vertical track;
C. inserting a first door in the upper horizontal track section; and
D. inserting additional foldable door into the lower horizontal track section.

9. The method of claim 8 wherein the additional foldable door comprises a screen panel door.
